(19) United States
(12) Patent Application Publication
(10) Pub. No.: US 2008/0031806 A1
(43) Pub. Date: Feb. 7, 2008

(54) Continuous process for making nanocrystalline metal dioxide

(76) Inventors: John Gavenonis, Wilmington, DE (US); Carmine Torardi, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/228,087

(22) Filed: Sep. 16, 2005

(51) Int. Cl. B01J 23/00; C01G 25/02; C01G 23/047

(52) U.S. Cl. 423/608; 502/350; 423/610; 423/611; 423/612

(57) ABSTRACT

The present invention is directed to a continuous process for forming a hydrated Group IVB metal oxide using continuous mixing followed by calcination to form a nanocrystalline mesoporous Group IVB metal oxide and particles produced thereby. The particles thus formed are readily dispersible.

### CROSS-REFERENCE TO RELATED APPLICATION

This disclosure is related to U.S. patent application Ser. Nos. 11/172,099; 11/171,055; 11/170,878; and 11/170,991 each filed on Jun. 30, 2005 which are continuations-in-part of Ser. No. 10/995,968 filed on Nov. 23, 2004 which are each incorporated by reference herein in their entireties.

### FIELD OF THE INVENTION

The present invention is directed to a process for forming a hydrated Group IVB metal oxide using continuous mixing, followed by calcination to form a nanocrystalline mesoporous Group IVB metal oxide and particles produced thereby. The particles thus formed are readily dispersible.

### BACKGROUND

The control of particle nanostructure and microstructure is an important commercial activity, useful, for example, in catalysis, electronics, optics, photovoltaics, and energy absorption applications. Control of particle nanostructure and microstructure allows control of physical and electronic properties, and is critical in the development of new functionalized materials. As an example, small, high surface area inorganic oxide particles disperse well in polymer binder systems for uniform coatings with specific tailored properties, such as light absorption/transmittance, porosity, and durability. It is well known that products having attributes such as small particles, high-surface area, and high porosity (porosity being determined by pore volume and average pore diameter) can be commercially useful in many applications including, without limitation, catalysts or catalyst supports.

One of the most widely used Group IVB metal oxides is titanium dioxide. Titanium dioxide is an important material because of its high refractive index and high scattering power for visible light, making it a good pigment in paints and coatings that require a high level of opacity. TiO₂ is also active as a photocatalyst in the decomposition of organic waste materials because it can strongly absorb ultraviolet light and use the absorbed energy in oxidation-reduction reactions. If the TiO₂ particles are made very small, less than about 100 nm, and if the photoactivity is suppressed by coating the TiO₂ particles, transparent films and coatings can be made that offer UV protection. Therefore, TiO₂ is a versatile material with many existing, as well as potential, commercial applications.

Several processes for the production of TiO₂ have been reported that use titanium tetrachloride (TiCl₄) as a starting source of titanium. TiCl₄ dissolved in a solvent is neutralized with a base, such as NH₄OH or NaOH, to precipitate a titanium-oxide solid that is washed to remove the salt byproducts, such as NH₄Cl and NaCl. Generally, the titanium-oxide solid thus formed is hydrated. For the reaction between TiCl₄ dissolved in a solvent and NH₄OH, the inclusion of the salt byproduct, NH₄Cl, in the precipitated solid in order to control the physical properties of the titania product has not been known.

U.S. Pat. No. 6,444,189 describes an aqueous process for preparing titanium oxide particles using TiCl₄ and NH₄OH followed by filtration and thorough washing of the precipitate to make a powder with a pore volume of 0.1 cc/g and pore size of 100 Å. Inoue et al. (British Ceramic Transactions 1998, Vol. 97, No. 5, p. 222) describe a procedure to make a washed amorphous TiO₂ gel by starting with TiCl₄ and a stoichiometric excess of NH₄OH solution. Publication No. CN 1097400A reacts TiCl₄ with NH₃ gas in alcohol solution to precipitate NH₄Cl salt, but the titanium product is an alkoxide. A hydrated TiO₂ is made by removing the NH₄Cl and hydrolyzing the separated liquid with water.

Co-owned and co-pending U.S. application Ser. Nos. 11/172099, 11/171055, 11/170878, and 11/170991 describe the production of mesoporous Group IVB metal oxides using a porogen and is hereby incorporated in its entirety.

### SUMMARY OF THE INVENTION

The present invention relates to a process for producing a Group IVB metal oxide, the process comprising:

continuously precipitating an ionic porogen and a hydrous Group IVB metal oxide, from a reaction mixture comprising a compound comprising a Group IVB metal, a base, and a solvent, wherein the compound comprising the Group IVB metal, the solvent, or both are a source of the anion for the ionic porogen and the base is the source of the cation for the ionic porogen; and

calcining said hydrous Group IVB metal oxide and ionic porogen precipitate to remove the ionic porogen to recover a Group IVB metal oxide product.

The invention also relates to the products made by this process. When the Group IVB metal is titanium, the product is a nanocrystalline titanium dioxide, said product comprising greater than 90% anatase material according to X-ray powder diffraction. The products made by this process are readily dispersible.

### BRIEF DESCRIPTION OF THE FIGURES

FIG. 1 depicts a graph illustrating the particle size distributions for Examples 1-4.

FIG. 2 depicts an X-ray Powder Diffraction pattern of the material made as described in Example 1.

FIGS. 3 and 4 depict transmission electron micrographs (TEMs) of the product of the process of Example 2.

### DETAILED DESCRIPTION

The present invention is directed to a process for forming a hydrated Group IVB metal oxide using continuous mixing, followed by calcination to form a nanocrystalline mesoporous Group IVB metal oxide, and the particles produced thereby. The particles thus produced can then be readily dispersed and used in a variety of applications.

As used herein, the term “mesoporous” means structures having an average pore diameter from about 20 up to and including about 800 Å (about 2 to about 80 nm).

The process of this invention uses a porogen. A porogen is a substance that can create porous structures by functioning as a template for the nanostructure and microstructure of the Group IVB metal oxide of this invention. The porogen can be removed to recover a mesoporous Group IVB metal oxide.

In one embodiment of the invention, the porogen is ionic. When the porogen is ionic, it can be formed in situ from the Group IVB metal compound or the solvent, or both, and a base. The Group IVB compound or the solvent can function as the source of the anion for the ionic porogen. The base can function as the source of the cation for the ionic porogen.

Alternatively, an ionic porogen can be added during the process, for example by addition of ammonium chloride to a mixture of a hydrolyzed compound comprising Ti and a liquid medium. When the process is a continuous one, the addition of the porogen to the mixture of hydrolyzed compound comprising Ti and liquid medium is done by any convenient method. The ionic porogen can be a halide salt. Typically, the halide salt is an ammonium halide which can optionally contain lower alkyl groups. The lower alkyl groups can be the same or different and can contain from 1 up to and including about 8 carbon atoms, typically less than about 4 carbon atoms. Longer chain hydrocarbons for the alkyl group of the ammonium halide can be detrimental in making a calcined product because of charring. Specific examples of ammonium halides containing lower alkyl groups include, without limitation, tetramethyl ammonium halide and tetraethyl ammonium halide. The halide can be fluoride, chloride, bromide, or iodide. Even more specifically, the halide is chloride or bromide. The ionic porogen can be a combination of halide salts such as a combination of ammonium halide, tetramethyl ammonium halide, and tetraethyl ammonium halide. Ammonium chloride is most preferred.

The porogen can be removed from the product of this invention to recover a mesoporous Group IVB metal oxide. Group IVB metal oxides include those elements identified as Group IVB by the CAS version of the Periodic Table of the Elements. Any suitable method for removing the porogen can be used, although for the present invention, volatilizing, particularly by calcining, is preferred, as that allows crystalline product to be formed.

The present invention is directed to any Group IVB metal oxide. When a titanium-comprising starting material is used, it is generally a halide (e.g., F, Cl, Br, or I) or an oxyhalide. Specific examples of useful titanium-comprising starting materials include titanium tetrachloride and titanium oxychloride. The foregoing starting materials can be made by well known techniques. As known to those skilled in the art, titanium tetrachloride dissolved in water forms a solution commonly referred to as titanium oxychloride.

A hydrous titanium oxide intermediate forms from the starting material for the titanium oxide in the presence of base or aqueous solvent.

A base can be used to precipitate the hydrous titanium oxide intermediate. A base can also serve as the source of cations for the porogen. Suitable bases for the practice of the invention can include, without limitation thereto, NH₄OH, (NH₄)₂CO₃, NH₄HCO₃, N(CH₃)₄OH, N(CH₃CH₂)₄OH, or other bases or mixture of bases whose cation is removable from the product of the invention by calcining. NH₄OH is preferred.

In one embodiment of the invention, a solvent can be used in the process of this invention. A suitable solvent will depend upon the reaction mechanism, as discussed below. Solvents can be aqueous or organic, depending upon the Group IVB metal starting material. Suitable aqueous solvents include water (when additional salt is added as discussed below) or aqueous halide salt such as aqueous ammonium halide. Suitable organic solvents include lower alkyl group alcohols and dimethylacetamide. Lower alkyl group alcohols which have been found to be particularly useful in producing metal oxides of this invention typically have up to and including 3 carbon atoms. Specific examples of lower alkyl group alcohols include, without limitation, ethanol, isopropanol, and n-propanol. A suitable solvent can also be the aqueous or organic solvent containing dissolved halide salt (e.g., ammonium halide), preferably a saturated solution of halide salt.

Solvents which have a low capacity to dissolve the porogen, such as aldehydes, ketones, and amines, may also be suitable solvents. For example, without limitation thereto, in order for ammonium halide formed in situ to precipitate and act as a porogen, saturated aqueous ammonium halide or organic solvents that have a low capacity to dissolve the ammonium halide can be used.

Other examples of suitable solvents for the Group IVB metal compound include, without limitation thereto, aqueous acid solutions, for example, an acid halide solution. Examples of acid halide solutions include, without limitation thereto, solutions of HCl, HBr, or HF.

The choice of solvent will depend upon the reaction mechanism and the porosity desired. When organic solvents are combined with aqueous reagents such as 50 wt % TiCl₄ in water and concentrated NH₄OH, the resulting organic-water liquid portion of the reaction mixture will dissolve more of the porogen than would be dissolved in the organic solvent alone. However, under the conditions of this invention, enough undissolved porogen must remain to ultimately produce a high-porosity metal oxide product. A solvent in which the metal starting material is soluble is typically used.

In a specific embodiment of the invention, it has been found that using solvents with low ammonium chloride solubility can yield TiO₂ having a high surface area, a pore volume of about 0.3 up to and including about 1.0 cc/g, and average pore diameter greater than about 300 Å.

These properties can be attained by performing the acid-base reaction in a solvent system having limited ammonium-chloride solubility, thereby precipitating more than about 50 wt % of the ammonium chloride, with precipitation of more than about 70 wt % being preferred, and precipitation of greater than about 90 wt % being most preferred. It is believed that the high porosity allows facile deagglomeration to TiO₂ nanoparticles.

A high water concentration in the reaction mixture will reduce pore volume by dissolving the water soluble porogen, thereby leaving less precipitated porogen available for creating pores.

Water can be introduced to the process through the source of the metal or through the source of the base. Some examples of water in the process are when the source of the metal or the base is an aqueous solution.

It has been found that the solubility of ammonium halide in an organic-water combination, or in saturated aqueous ammonium halide, and the influence of ammonium halide solubility on the porosity of the product metal oxide, can be affected by the form of the metal starting material. For example, TiCl₄ can be introduced neat and anhydrous, or it can be combined with water to make an aqueous solution which can be referred to as titanium oxychloride solution. For this titanium oxychloride solution, as the H₂O:TiCl₄ weight ratio increases, ammonium halide solubility increases, which will result in a decrease in product porosity. Similar results would be obtained for aqueous solutions of base as the water:base ratio increases. Other solvent-specific factors can influence the pore volume of the metal oxide product and the subsequent production of nanoparticles. For example, different rates of precipitation of the porogen and the metal-oxide, and different rates of crystallization of the porogen and the metal oxide can impact the nature of the composite precipitate and the ability of the precipitated ammonium halide to produce the high porosity nanoparticulate metal oxide product of this invention.

The concentration of the metal starting material can be in the range of about 0.01 M to about 5.0 M, preferably about 0.05 M to about 0.5 M. The metal starting material may be in the form of a neat liquid or solid, or, preferably, as an aqueous or organic solution.

There are several ways in which the hydrolyzed metal compound and the porogen can be precipitated.

In one embodiment, a solvent is combined with the metal starting material to form a solution. The solvent-metal-starting material solution is mixed with a base to precipitate the hydrous metal oxide and the porogen. For example, without limitation thereto, in the synthesis of TiO₂, titanium chloride as the neat liquid, or as an aqueous solution such as 50 wt % TiCl₄ in water (based on the entire weight of the solution) may be combined with solvent. The solvent-titanium-chloride solution so formed is then combined with ammonium hydroxide in a continuous process to precipitate the hydrolyzed compound containing titanium and the porogen, ammonium chloride.

In another embodiment of the invention, a solvent is first combined with the base. The solvent-base mixture is then combined in a continuous process with the metal starting material to form a precipitate of the metal oxide and the porogen. For example, without limitation thereto, in the synthesis of TiO₂, NH₄OH may be combined with the solvent to form the solvent-base mixture, which is then combined with titanium chloride or titanium oxychloride to precipitate the hydrolyzed compound containing titanium and the porogen, ammonium chloride.

Thus, the process further comprises contacting an aqueous solution of the compound containing the Group IVB metal with a first portion of the solvent to form a precipitate-containing slurry; adding the base to a second portion of the solvent to form a solution, which can be solvent-base mixture; and combining the slurry and the solution to continuously precipitate the ionic porogen and the hydrous Group IVB metal oxide.

In general, after blending together the starting materials in a continuous manner using, for example, a T-mixer, a Y-mixer, a rotor-stator mixer, or similar device, the resulting mixture may be further mixed, preferably at room temperature, for about 1 minute or less, but may continue to mix for several hours. It is generally preferable to continue mixing to keep the formed solids in suspension for further processing. Normally, mixing for 5-60 minutes will suffice. A mixed metal-oxide/halide-salt precipitate can be recovered by any convenient method, including settling followed by decanting of the supernatant liquid, filtration, centrifugation and so forth.

The porogen is then removed to form the mesoporous agglomerated metal oxide product of the invention. The agglomerated metal oxide product can be deagglomerated by methods known to those skilled in the art to give metal oxide nanoparticles.

In another embodiment of the invention, a sufficient quantity of a halide salt can be added after precipitating the hydrolyzed metal oxide to saturate the liquid medium. The solid recovered from the saturated liquid medium comprises a hydrolyzed metal compound having pores containing the saturated liquid medium. The saturated liquid medium is removed from the solid to recover the mesoporous titanium oxide, which can be used to produce a dispersion of nanoparticles. Typically, the liquid medium is the liquid portion of the mixture of solvent, with or without dissolved salt, and the hydrous metal oxide. As an example, without being limited thereto, a metal starting material is combined with water to form a solution. The solution so formed is mixed with a base to form a mixture comprising precipitated hydrous metal oxide and liquid medium. To that mixture is added halide salt to saturate the liquid medium. Thereafter, the mesoporous product is recovered by removing the saturated liquid medium. In the present invention, this is accomplished by isolating the solids, allowing them to dry, and then calcining them to remove the porogen which remains after drying.

If a high surface area, mesoporous, nanocrystalline, metal oxide is desired, the hydrolyzed metal compound and porogen, however collected, can be calcined at a temperature that removes the porogen. Generally, the calcination temperature is at least the sublimation or decomposition temperature of the porogen. Typically the calcination temperature will range from about 300° C. to about 600° C., preferably between about 350° C. and about 550° C., and more preferably between about 400° C. and 500° C.

In the case of preparing TiO₂ from TiCl₄ and NH₄OH in saturated aqueous NH₄Cl, the 450° C.-calcined product is composed of agglomerated nanocrystals of anatase, although some rutile, brookite, or X-ray amorphous material may also be present. The size of the anatase nanocrystals is a function of the calcination temperature and calcination time. At a calcination temperature of 450° C. and a calcination time of one hour or greater, the average crystallite size can be from about 10-15 nm. Generally, the product will be greater than or equal to 90% anatase when measured by X-ray powder diffraction.

The solvent can be separated and recycled. The volatiles, including the porogen, can be condensed, and then recycled or disposed.

The pH of the system is generally in the range of about 4 to about 10, preferably from about 5 to about 9, and most preferably between about 6 and about 8. In a continuous process, the pH of the system is generally controlled better than with a batch process because it is believed that the material produced is exposed to less environmental pH variability.

In one embodiment of the invention, the Group IVB metal oxide further comprises a dopant which can be a transition metal, or a Group IIA, IIIA, IVA, or VA element. Specifically, without limitation thereto, the dopant can be Mg, Ca, Sr, Ba, Sc, Y, La, Ti, Zr, Hf, V, Nb, Ta, Cr, Mo, W, Mn, Fe, Co, Ni, Cu, Zn, B, Al, Ga, In, Si, Ge, Sn, P, As, Sb, or Bi. Methods for incorporating dopants into the metal oxide would be apparent to those skilled in the art. For example, a dopant-containing compound could be added with the metal-containing starting material. Generally, dopants are added in very small amounts, typically less than about 5 atomic percent based on the Group IVB metal.

Compositions of matter of this invention can be used as a catalyst or catalyst support. For example, the catalytic properties of TiO₂ are well known to those skilled in the catalyst art. Use of the compositions of matter of this invention as catalysts or catalyst supports would be apparent to those skilled in the catalyst art.

Compositions of matter of this invention can be used as nanoparticle precursors. The TiO₂ agglomerates formed by the process of this invention can be formed into nanoparticles by any suitable deagglomeration technique. As an example, the product of this invention can be deagglomerated by combining the product with water and a suitable surfactant such as, without being limited thereto, tetrasodiumpyrophosphate, followed by sonication to break-up the agglomerates. However, other suitable techniques for breaking-up the agglomerates would be apparent to those skilled in the metal oxide powder or nanoparticle art. Typically, deagglomeration is accomplished by sonication or media milling. The nanoparticle precursor of the invention can be deagglomerated to a degree sufficient to form agglomerates considered to fall within the nanoparticle size range, typically having an average agglomerate size diameter which is less than about 200 nanometers.

The deagglomerated titanium dioxide product of this invention, if photo passivated, can be especially useful for UV light degradation resistance in plastics, sunscreens, and other protective coatings including paints and stains.

The titanium dioxide product of this invention can be photo passivated by treatment with silica and/or alumina, by any of several methods which are well known in the art including, without limit, silica and/or alumina wet treatments used for treating pigment-sized titanium dioxide.

The titanium dioxide product of this invention can also have an organic coating which may be applied using techniques known by those skilled in the art. A wide variety of organic coatings are known. Organic coatings employed for pigment-sized titanium dioxide may be utilized.

Examples of organic coatings that are well known to those skilled in the art include fatty acids, such as stearic acid; fatty acid esters; fatty alcohols, such as stearyl alcohol; polyols such as trimethylpropane diol or trimethyl pentane diol; acrylic monomers, oligomers, and polymers; and silicones, such as polydimethylsiloxane and reactive silicones such as methylhydroxysiloxane. Organic coating agents can include, but are not limited to, carboxylic acids such as adipic acid, terephthalic acid, lauric acid, myristic acid, palmitic acid, stearic acid, oleic acid, salicylic acid, malic acid, and maleic acid; esters; fatty acid esters; fatty alcohols such as stearyl alcohol or salts thereof; polyols such as trimethylpropane diol or trimethyl pentane diol; and acrylic monomers, oligomers, and polymers. In addition, silicon-containing compounds are also of utility. Examples of silicon compounds include, but are not limited to, silicates or organosilanes or siloxanes including silicate; organoalkoxysilanes; aminosilanes; epoxysilanes; and mercaptosilanes such as hexyltrimethoxysilane, octyltriethoxysilane, nonyltriethoxysilane, decyltriethoxysilane, dodecyltriethoxysilane, tridecyltriethoxysilane, tetradecyltriethoxysilane, pentadecyltriethoxysilane, hexadecyltriethoxysilane, heptadecyltriethoxysilane, octadecyltriethoxysilane, N-(2-aminoethyl)-3-aminopropylmethyl dimethoxysilane, N-(2-aminoethyl)-3-aminopropyl trimethoxysilane, 3-aminopropyl triethoxysilane, 3-glycidoxypropyl trimethoxysilane, 3-glycidoxypropyl methyldimethoxysilane, 3-mercaptopropyl trimethoxysilane, and combinations of two or more thereof. Polydimethylsiloxane and reactive silicones such as methylhydroxysiloxane may also be useful.

The titanium dioxide product of this invention may also be coated with a silane having the formula:

RₓSi(R′)₄₋ₓ

wherein

### R is a nonhydrolyzable aliphatic, cycloaliphatic, or aromatic group having at least 1 to about 20 carbon atoms;

### R′ is a hydrolyzable group such as an alkoxy, halogen, acetoxy, or hydroxy or mixtures thereof; and

### X=1 to 3.

For example, silanes useful in coating the product of the invention include hexyltrimethoxysilane, octyltriethoxysilane, nonyltriethoxysilane, decyltriethoxysilane, dodecyltriethoxysilane, tridecyltriethoxysilane, tetradecyltriethoxysilane, pentadecyltriethoxysilane, hexadecyltriethoxysilane, heptadecyltriethoxysilane and octadecyltriethoxysilane. Additional examples of silanes include, R=8-18 carbon atoms; R′=chloro, methoxy, hydroxyl, or mixtures thereof; and x=1 to 3. Preferred silanes are R=8-18 carbon atoms; R′=ethoxy; and x=1 to 3. Mixtures of silanes are contemplated equivalents. The weight content of the treating agent, based on total treated particles can range from about 0.1 to about 10 wt. %, preferably about 0.5 to about 7.0 wt. % and more preferably from about 0.7 to about 5 wt %.

The titanium dioxide particles of this invention can be silanized as described in U.S. Pat. Nos. 5,889,090; 5,607,994; 5,631,310; and 5,959,004 which are each incorporated by reference herein in their entireties.

The titanium dioxide product of this invention may be treated to have any one or more of the foregoing organic coatings.

Titanium dioxide product made according to the present invention may be used with advantage in various applications including, without limitation, coating formulations such as sunscreens, cosmetics, automotive coatings, wood coatings, and other surface coatings; chemical mechanical planarization products; catalyst products; photovoltaic cells; plastic parts, films, and resin systems including agricultural films, food packaging films, molded automotive plastic parts, and engineering polymer resins; rubber based products including silicone rubbers; textile fibers, woven and nonwoven applications including polyamide, polyaramid, and polyimides fibers products and nonwoven sheets products; ceramics; glass products including architectural glass, automotive safety glass, and industrial glass; electronic components; and other uses in which photo and chemically passivated titanium dioxide will be useful.

Thus in one embodiment, the invention is directed to a coating composition suitable for protection against ultraviolet light comprising an additive amount of photo passivated titanium dioxide nanoparticles, made in accordance with this invention, dispersed in a protective coating formulation, and suitable for imparting protection against ultraviolet light.

One area of increasing demand for titanium dioxide nanoparticles is in cosmetic formulations, particularly in sunscreens as a sunscreen agent. Titanium dioxide nanoparticles provide protection from the harmful ultraviolet rays of the sun (UV A and UV B radiation).

A dispersant is usually required to effectively disperse titanium dioxide nanoparticles in a fluid medium. Careful selection of dispersants is important. Typical dispersants for use with titanium dioxide nanoparticles include aliphatic alcohols, saturated fatty acids, and fatty acid amines.

The titanium dioxide nanoparticles of this invention can be incorporated into a sunscreen formulation. Typically the amount of titanium dioxide nanoparticles can be up to and including about 25 wt %, preferably from about 0.1 wt % up to and including about 15 wt %, even more preferably up to and including about 6 wt %, based on the weight of the formulation, the amount depending upon the desired sun protection factor (SPF) of the formulation. The sunscreen formulations are usually an emulsion and the oil phase of the emulsion typically contains the UV active ingredients such as the titanium dioxide particles of this invention. Sunscreen formulations typically contain in addition to water, emollients, humectants, thickeners, UV actives, chelating agents, emulsifiers, suspending agents (typically if using particulate UV actives), waterproofers, film forming agents, and preservatives.

Specific examples of preservatives include parabens. Specific examples of emollients include octyl palmitate, cetearyl alcohol, and dimethicone. Specific examples of humectants include propylene glycol, glycerin, and butylene glycol. Specific examples of thickeners include xanthan gum, magnesium aluminum silicate, cellulose gum, and hydrogenated castor oil. Specific examples of chelating agents include disodium ethylene diaminetetraacetic acid (EDTA) and tetrasodium EDTA. Specific examples of UV actives include ethylhexyl methoxycinnamate, octocrylene, and titanium dioxide. Specific examples of emulsifiers include glyceryl stearate, polyethyleneglycol-100 stearate, and ceteareth-20. Specific examples of suspending agents include diethanolamine-oleth-3-phosphate and neopentyl glycol dioctanoate. Specific examples of waterproofers include C30-38 olefin/isopropyl maleate/MA copolymer. Specific examples of film forming agents include hydroxyethyl cellulose and sodium carbomer.

To facilitate use by the customer, producers of titanium dioxide nanoparticles may prepare and provide dispersions of the particles in a fluid medium which are easier to incorporate into formulations.

Water-based wood coatings, especially colored transparent and clear coatings, benefit from a UV stabilizer which protects the wood. Organic UV absorbers are typically hydroxybenzophenones and hydroxyphenyl benzotriazoles. A commercially available UV absorber is sold under the trade name Tinuvin™ by Ciba. These organic materials, however, have a short life and decompose on exterior exposure. Replacing some or all of the organic material with titanium dioxide nanoparticles would allow very long lasting UV protection. Photo passivated titanium dioxide of this invention may be used to prevent the titanium dioxide from oxidizing the polymer in the wood coating, and be sufficiently transparent so the desired wood color can be seen. The titanium dioxide needs to be dispersible in the water phase because most wood coatings are water based. Various organic surfactants known in the art can be used to disperse the titanium dioxide nanoparticles in water.

Many cars are now coated with a clear layer of polymer coating to protect the underlying color coat, and ultimately the metal body parts. This layer has organic UV protectors, and like wood coatings, a more permanent replacement for these materials is desired. The clear coat layers are normally solvent-based, but can also be water-based. Such coatings are well known in the art. The titanium dioxide nanoparticles of this invention can be modified for either solvent- or water-based systems with appropriate surfactants or organic surface treatments.

When treated for reduced photoactivity, the titanium dioxide particles of this invention can be beneficial in products which degrade upon exposure to UV light energy such as thermoplastics and surface coatings.

Titanium dioxide nanoparticles can also be used to increase the mechanical strength of thermoplastic composites. Most of these applications also require a high degree of transparency and UV attenuation so underlying color or patterns are visible and the plastic is not degraded by the photoactivity of the titanium dioxide nanoparticles. The titanium dioxide nanoparticles must be compatible with the plastic and easily compounded into it. This application typically employs organic surface modification of the titanium dioxide nanoparticles as described herein above. The foregoing thermoplastic composites are well known in the art.

Polymers which are suitable as thermoplastic materials for use in the present invention include, by way of example but not limited thereto, polymers of ethylenically unsaturated monomers including olefin-based polymers such as polyethylene, polypropylene, polybutylene, and copolymers of ethylene with higher olefins such as alpha olefins containing 4 to 10 carbon atoms or vinyl acetate, etc.; vinyls such as polyvinyl chloride, polyvinyl esters such as polyvinyl acetate, polystyrene, acrylic homopolymers, and copolymers; phenolics; alkyds; amino resins; epoxy resins, polyamides, polyurethanes; phenoxy resins, polysulfones; polycarbonates; polyether and chlorinated polyesters; polyethers; acetal resins; polyimides; and polyoxyethylenes. The polymers according to the present invention also include various rubbers and/or elastomers, either natural or synthetic polymers based on copolymerization, grafting, or physical blending of various diene monomers with the above-mentioned polymers, all as generally well known in the art. Thus generally, the present invention is useful for any plastic or elastomeric compositions (which can also be pigmented with pigmentary TiO₂). For example, but not by way of limitation, the invention is felt to be particularly useful for polyolefins such as polyethylene and polypropylene, polyvinyl chloride, polyamides, and polyester.

From the refractive index of compositions of matter of this invention it would be apparent to those skilled in the optics art that the compositions of this invention can be useful in optics. The TiO₂ product of this invention could be combined with polymethylmethacrylate polymer and made into an optical device. Other techniques for incorporating the compositions of this invention into optical devices would be apparent to those skilled in the art of making optical devices.

Additionally, compositions of matter of this invention can be useful in electronics. For example the TiO₂ product of this invention could be used in photovoltaic devices. For instance, a TiO₂ product can be combined with a binder and cast into a film on a conducting substrate by well-known techniques to form a component of an anode which can be used in a solar cell. Other suitable techniques for incorporating products of this invention into photovoltaic devices would be apparent to those skilled in the electronics art. TiO₂ products of this invention can provide high powder conversion efficiency in solar cell applications.

Compositions of matter of this invention can be used in a battery as a major component of the anode. For example, the electrochemical properties of titanium in a lithium battery are well known to those skilled in the battery art, and the titanium dioxide product of this invention can be used in making an anode of a battery by techniques known to those skilled in the battery art.

In one embodiment, the invention herein can be construed as excluding any element or process step that does not materially affect the basic and novel characteristics of the composition or process. Additionally, the invention can be construed as excluding any element or process step not specified herein.

Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The examples which follow, description of illustrative and preferred embodiments of the present invention are not intended to limit the scope of the invention. Various modifications, alternative constructions and equivalents may be employed without departing from the true spirit and scope of the appended claims.

### TEST METHODS

The following test methods and procedures were used in the Examples below:

X-ray Powder Diffraction: Room-temperature powder X-ray diffraction data were obtained with a Philips X'PERT automated powder diffractometer, Model 3040. Samples were run in batch mode with a Model PW 1775 or Model PW 3065 multi-position sample changer. The diffractometer was equipped with an automatic variable slit, a xenon proportional counter, and a graphite monochromator. The radiation was CuK(alpha) (45 kV, 40 mA). Data were collected from 2 to 60 degrees 2-theta; a continuous scan with an equivalent step size of 0.03 deg; and a count time of 0.5 seconds per step.

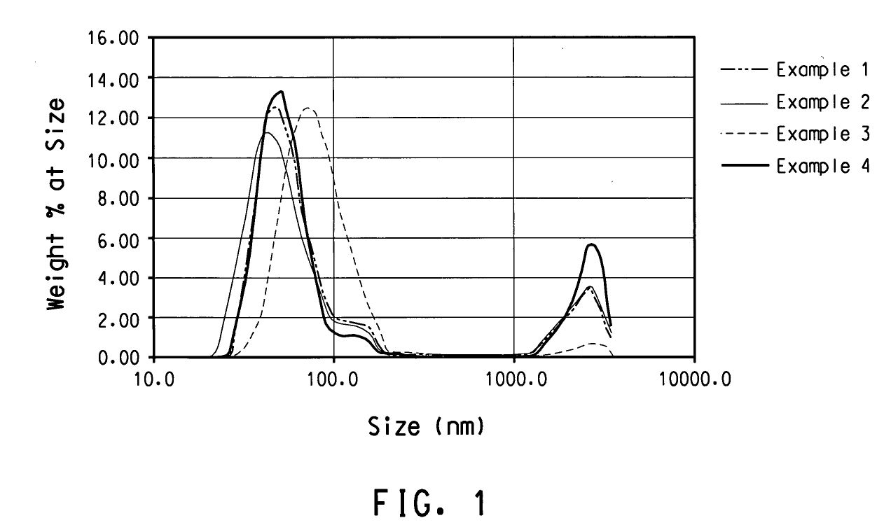

Particle Size Distribution (PSD): Particle size distributions were measured with a Malvern Nanosizer Dynamic Light Scattering Unit on suspensions containing 0.1 wt % TiO₂. The materials were sonicated in an aqueous solution of 0.1 wt % TSPP (tetrasodiumpyrophosphate, CAS number 7722-88-5) to form a dispersion. The particle size distributions were calculated for particles less than 1000 nm and are given in Table 1 below. An oversize fraction of particles was observed in the samples, and the amount of these larger agglomerated particles is shown in Table 1 as the mass percent greater than 1000 nm. In general, it has been found that the oversize particles can be deagglomerated into particles having sizes less than about 200 nm by mechanical milling, e.g., media-milling. FIG. 1 shows the PSD plot for the four Examples given below.

### EXAMPLES

In the following Examples, titanium dioxide was formed and characterized.

All chemicals and reagents were used as received from:

| | |
|---|---|
| TiCl₄ | Aldrich Chemical Co., Milwaukee, WI, 99.9% |
| NH₄OH | EMD Chemicals, Gibbstown, NJ, 28.0-30.0% |
| NH₄Cl | EMD Chemicals, Gibbstown, NJ, 99.5% |
| TSPP | EM Science, Gibbstown, NJ, >99% |

A 50 wt % solution of TiCl₄ in water was prepared by slow addition of TiCl₄ into cold (i.e., ice bath temperature), stirring, deionized water in a Pyrex® beaker.

All references herein to elements of the Periodic Table of the Elements are to the CAS version of the Periodic Table of the Elements.

### Example 1

This example illustrates how a Y-mixer can be used to prepare a calcined, nanocrystalline TiO₂ powder that can be deagglomerated via sonication to give d₅₀<70 nm in the particle size distribution.

A 50 wt % solution of TiCl₄ in H₂O (28.0 mL) was added to a saturated aqueous solution of NH₄Cl (200 mL). This caused significant precipitation of NH₄Cl to make an aqueous slurry. Separately, NH₄OH (30 mL, 14.8 M) was added to a saturated aqueous solution of NH₄Cl (200 mL). No precipitate formed. The slurry and the solution were each gently stirred separately using Teflon®-coated magnetic stirring bars in 500 mL Pyrex® Erlenmeyer flasks. A Cole-Parmer peristaltic pump with two size 16 pump heads and silicone tubing was used to combine the slurry and the solution in a Y-joint with a flow rate of approximately 80 mL/min. As the two streams were combined, a white precipitate formed. The pH of the resulting slurry, measured with multi-color strip pH paper, was about 8.

The solid was collected by vacuum filtration (0.45 μm, Nylon filter) and air dried for several days to give a white solid. The solid was then pulverized using a mortar/pestle, transferred to an alumina crucible, heated uncovered (calcined) from room temperature to 400° C. over the period of 1 h, and held at 400° C. for 20 h. The firing was done under a constant air flow to help remove the sublimed NH₄Cl byproduct. The crucible and its contents were removed from the furnace and cooled to room temperature under ambient conditions.

The resulting TiO₂ powder was dispersed by shaking in water containing 0.1 wt % TSPP surfactant. The particle size distribution data for this powder after 10 minutes of sonication are shown in Table 1, and FIG. 1.

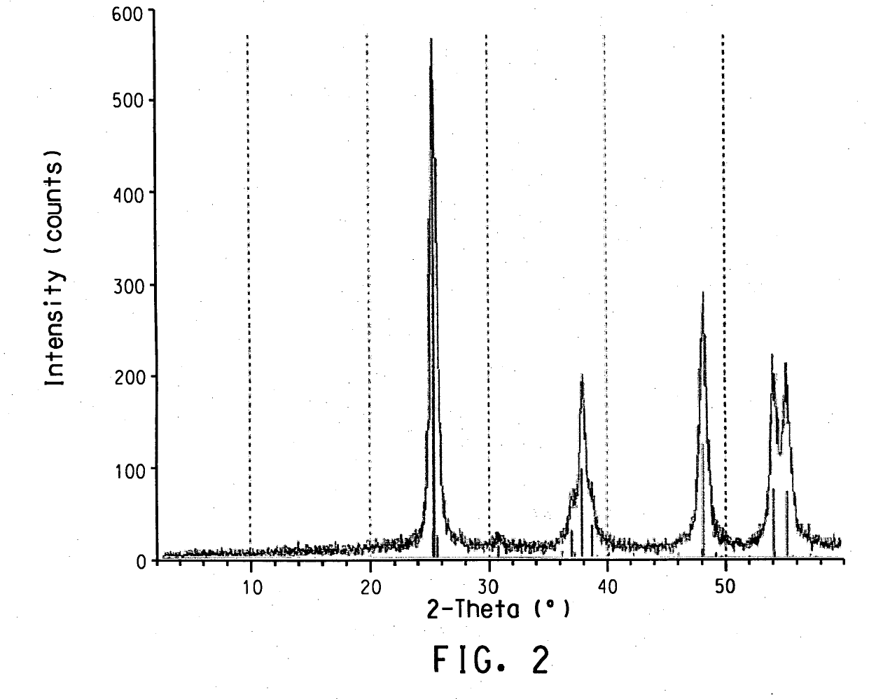

The X-ray powder diffraction pattern for TiO₂ powder made as described in this Example is shown in FIG. 2. The pattern clearly shows a predominance of anatase TiO₂ present.

### Example 2

This example shows how modifying the reaction concentration to one-half the concentration used in Example 1 decreases the particle size distribution for calcined, nanocrystalline TiO₂.

A 50 wt % solution of TiCl₄ in H₂O (28.0 mL) was added to a saturated aqueous solution of NH₄Cl (400 mL). An aqueous slurry containing some NH₄Cl precipitation was observed. Separately, NH₄OH (30 mL, 14.8 M) was added to a saturated aqueous solution of NH₄Cl (400 mL). No precipitate formed. The slurry and the solution were gently stirred separately using Teflon®-coated magnetic stirring bars in 500 mL Pyrex® Erlenmeyer flasks. A Cole-Parmer peristaltic pump with two size 16 pump heads and silicone tubing was used to combine the slurry and the solution in a Y-joint with a flow rate of approximately 80 mL/min. As the two streams were combined, a white precipitate formed. The pH of the resulting slurry, measured with multi-color strip pH paper, was about 6-7.

The solid was collected by vacuum filtration (0.45 μm, Nylon filter) and dried under an IR heat lamp to give a white solid. The solid was then pulverized using a mortar/pestle, transferred to an alumina crucible, heated uncovered (calcined) from room temperature to 400° C. over the period of 1 h, and held at 400° C. for 20 h. The firing was done under a constant air flow to help remove the sublimed NH₄Cl byproduct. The crucible and its contents were removed from the furnace and cooled to room temperature under ambient conditions.

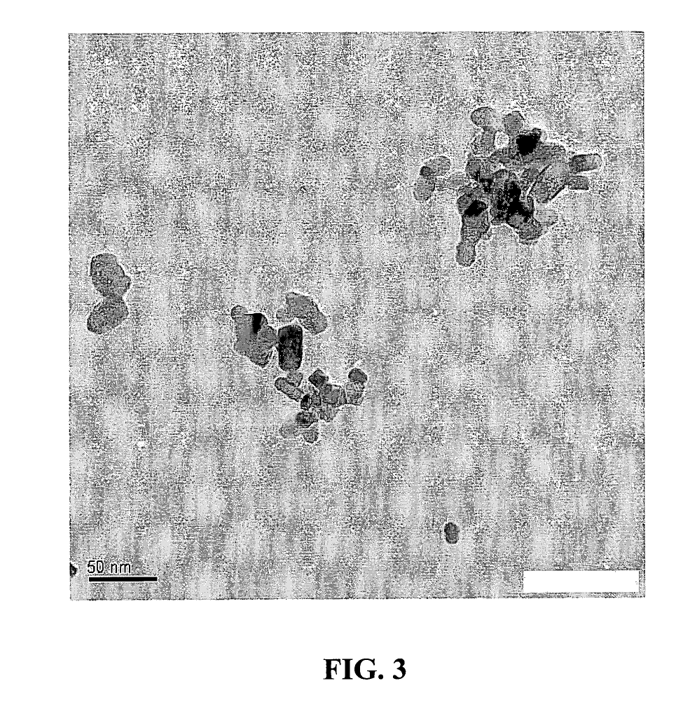

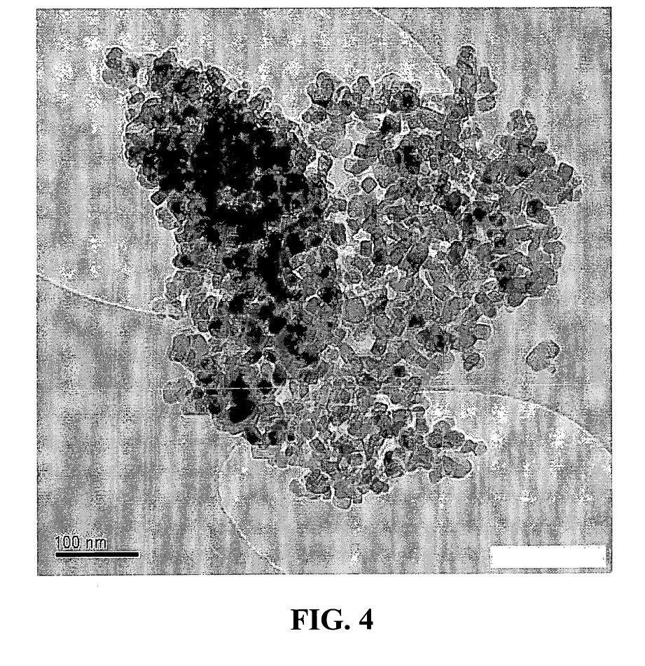

TEM images are shown in FIGS. 3 and 4, showing the TiO₂ crystallites and agglomerates.

The resulting TiO₂ powder was dispersed by shaking in water containing 0.1 wt % TSPP surfactant. The particle size distribution data for this powder after 10 minutes of sonication are shown in Table 1 and FIG. 1.

### Example 3

This example shows how modifying the reaction concentration to one-quarter the concentration used in Example 1 decreases the particle size distribution for calcined, nanocrystalline TiO₂.

A 50 wt % solution of TiCl₄ in H₂O (14.0 mL) was added to a saturated aqueous solution of NH₄Cl (400 mL). An aqueous slurry with only a slight amount of NH₄Cl precipitation was observed. Separately, NH₄OH (15 mL, 14.8 M) was added to a saturated aqueous solution of NH₄Cl (400 mL). No precipitate formed. The slurry and the solution were gently stirred separately using Teflon®-coated magnetic stirring bars in 500 mL Pyrex® Erlenmeyer flasks. A Cole-Parmer peristaltic pump with two size 16 pump heads and silicone tubing was used to combine the slurry and the solution in a Y-joint with a flow rate of approximately 72 mL/min. As the two streams were combined, a white precipitate formed. The pH of the resulting slurry, measured with multi-color strip pH paper, was about 6-7.

The solid was collected by vacuum filtration (0.45 μm, Nylon filter) and air dried for several days to give a white solid. The solid was then pulverized using a mortar/pestle, transferred to an alumina crucible, heated uncovered (calcined) from room temperature to 400° C. over the period of 1 h, and held at 400° C. for 20 h. The firing was done under a constant air flow to help remove the sublimed NH₄Cl byproduct. The crucible and its contents were removed from the furnace and cooled to room temperature under ambient conditions.

The resulting TiO₂ powder was dispersed by shaking in water containing 0.1 wt % TSPP surfactant. The particle size distribution data for this powder after 10 minutes of sonication are shown in Table 1 and FIG. 1.

### Example 4

This example shows how a rotor-stator can be used in place of a Y-mixer to prepare calcined TiO₂ (using the same reaction concentration as in Example 3). The particle size distribution data obtained for this reaction is comparable, though shifted to slightly larger particle sizes, to that obtained for Y-mixer reactions.

A 50 wt % solution of TiCl₄ in H₂O (14.0 mL) was added to a saturated aqueous solution of NH₄Cl (400 mL). An aqueous slurry with only a slight amount of NH₄Cl precipitation was observed. Separately, NH₄OH (15 mL, 14.8 M) was added to a saturated aqueous solution of NH₄Cl (400 mL). No precipitate formed. The slurry and the solution were gently stirred separately using Teflon®-coated magnetic stirring bars in 500 mL Pyrex® Erlenmeyer flasks. A Cole-Parmer peristaltic pump with two size 16 pump heads and silicone tubing was used to combine the slurry and the solution with a flow rate of approximately 59 mL/min in a rotor-stator operating at 8000 rpm. As the two streams were combined, a white precipitate formed. The pH of the resulting slurry, measured with multi-color strip pH paper, was about 8.

The solid was collected by vacuum filtration (0.45 μm, Nylon filter) and air dried for several days to give a white solid. The solid was then pulverized using a mortar/pestle, transferred to an alumina crucible, heated uncovered (calcined) from room temperature to 400 ° C. over the period of 1 h, and held at 400° C. for 20 h. The firing was done under a constant air flow to help remove the sublimed NH₄Cl byproduct. The crucible and its contents were removed from the furnace and cooled to room temperature under ambient conditions.

The resulting TiO₂ powder was dispersed by shaking in water containing 0.1 wt % TSPP surfactant. The particle size distribution data for this powder after 10 minutes of sonication are shown in Table 1 and FIG. 1.

TABLE 1
PSD by Malvern ZetaSizer of TiO₂ Powders from Mixer Experiments

| | | Reaction | | | | |
|---|---|---|---|---|---|---|
| | | Conc. | | | | |
| | Mixing | and | d₁₀ | d₅₀ | | % > |
| Sample | Method | Solvent | (nm) | (nm) | d₉₀ (nm) | 1000 nm |
| Example 1 | Y-mixer | 0.23 M | 41.7 | 58.7 | 104.0 | 15.9 |
| | | NH₄Cl | | | | |
| Example 2 | Y-mixer | 0.12 M | 35.7 | 53.7 | 103.0 | 16.1 |
| | | NH₄Cl | | | | |
| Example 3 | Y-mixer | 0.06 M | 53.8 | 74.8 | 137.0 | 2.7 |
| | | NH₄Cl | | | | |
| Example 4 | Rotor- | 0.06 M | 42.1 | 57.3 | 94.2 | 21.0 |
| | Stator | NH₄Cl | | | | |

What is claimed is:

1. A process for producing a Group IVB metal oxide, the process comprising:
continuously precipitating an ionic porogen and a hydrous Group IVB metal oxide, from a reaction mixture comprising a compound comprising a Group IVB metal, a base, and a solvent, wherein the compound comprising the Group IVB metal, the solvent, or both, are a source of the anion for the ionic porogen and the base is the source of the cation for the ionic porogen; and
calcining said hydrous Group IVB metal oxide and ionic porogen precipitate to remove the ionic porogen to recover a Group IVB metal oxide product.

2. The process of claim 1 further comprising contacting an aqueous solution of the compound containing the Group IVB metal, with a first portion of the solvent to form a slurry; adding the base to a second portion of the solvent to form a solution; and combining the slurry and the solution to continuously precipitate the ionic porogen and the hydrous Group IVB metal oxide.

3. The process of claim 1, wherein the compound comprising a Group IVB metal is TiCl₄ or a derivative thereof, and the recovered Group IVB metal oxide product is TiO₂.

4. The process of claim 1, wherein the ionic porogen is ammonium chloride.

5. The process of claim 1, wherein the ionic porogen and hydrous Group IVB metal oxide are precipitated by continuous mixing.

6. The process of claim 5, wherein said continuous mixing is achieved using a T-mixer, a Y-mixer, or a rotor-stator mixer.

7. The process of claim 1, wherein the solvent is selected from the group consisting of ethanol, n-propanol, i-propanol, dimethyl acetamide, alcoholic ammonium halide, and aqueous ammonium halide, or combinations thereof.

8. The process of claim 7, wherein the ammonium halide is ammonium chloride.

9. The process of claim 1, wherein the base is selected from the group consisting of NH₄OH, NH₄HCO₃, (NH₄)₂CO₃, N(CH₃)₄OH, or N(CH₃CH₂)₄OH.

10. The process of claim 3, wherein said TiO₂ is greater than 90% anatase TiO₂.

11. The process of claim 10, wherein said anatase TiO₂ has a d₅₀ particle size of 30 nm to 300 nm after dispersion.

12. The process of claim 10, wherein said anatase TiO₂ has a d₅₀ particle size of 40 nm to 80 nm after dispersion.

13. The process of claim 1, wherein said calcining is done at temperatures of 300° C. to 600° C.

14. The use of the metal oxide product of claim 1 as a catalyst or catalyst support.

15. The use of the metal oxide product of claim 1 as a nanoparticle precursor.

16. The use of the metal oxide product of claim 1 in an optical device or an electronic device.

17. The use of the metal oxide product of claim 1 in a photovoltaic cell.

18. The metal oxide of claim 1 which is treated with silica, alumina or both.

19. The metal oxide of claim 1 which is treated with an organic agent.

20. The titanium dioxide of claim 19 in which the organic agent is a silane or a siloxane.

21. The use of the metal oxide of claim 1 in a thermoplastic composition.

22. The use of the metal oxide of claim 1 in a protective coating composition.
